(19) United States
(12) Patent Application Publication
(10) Pub. No.: US 2006/0019009 A1
(43) Pub. Date: Jan. 26, 2006

(54) Low carbohydrate direct expanded snack and method for making

(76) Inventors: Lewis Conrad Keller, McKinney, TX (US); Richard Lai, Plano, TX (US); Jason Thomas Niermann, Frisco, TX (US); V.N. Mohan Rao, Plano, TX (US); James William Stalder, Dallas, TX (US)

Correspondence Address: CARSTENS & CAHOON, LLP, P O BOX 802334, DALLAS, TX, 75380, US

(21) Appl. No.: 10/899,263

(22) Filed: Jul. 26, 2004

(51) Int. Cl. A23L 1/00

(52) U.S. Cl. 426/516

(57) ABSTRACT

A method for making a low carbohydrate high protein puffed snack food product. Ingredients comprising soy isolate, soy concentrate, corn meal, and water are introduced into an extrudate. The ingredients are extruded through a die orifice at a high specific mechanical energy. The ingredient formula ranges have been determined that maximize volumetric expansion and the set operating conditions and keep texture, color, and flavor acceptable. The puffed snack is then dried and seasoned. There are minimal off-flavors in the product.

### BACKGROUND OF THE INVENTION

1. Technical Field

The present invention relates to the production of a low carbohydrate shelf stable snack food with minimal reduction of organoleptical properties and in particular to a low carbohydrate direct expanded or puff extrudate with taste and texture characteristics similar to conventionally produced puffed snack products.

2. Description of Related Art

Puffed snack food products are popular consumer items for which there exists a great demand. The production in the prior art of a puffed extruded product or direct expanded product, such as snacks produced and marketed under the Cheetos® brand label, typically involves extruding a corn meal and/or other raw materials through a die having a small orifice at extremely high pressure. The extrudate flashes off its inherent and added moisture, or puffs, as it exits the small orifice, thereby forming a puff extrudate upon reaching atmospheric pressure after extrusion. As disclosed in U.S. Pat. No. 6,607,772, assigned to the same assignee of the present invention, the typical ingredients for the starting raw material consists of corn meal and water. Unfortunately, corn meal is a high carbohydrate food. The carbohydrate calories present in puffed snack products are derived primarily from the corn meal content.

Recently, consumer demand for products low in carbohydrates has dramatically increased, as the popularity of low carbohydrate diets has increased. According to one recent newspaper account, 40% of consumers say they are watching their carbohydrate intake. There are currently numerous low carbohydrate diets being marketed to consumers. Such an example is exemplified by U.S. Pat. No. 5,855,949, which discloses a dietary system for the treatment of obesity that prescribes foods that are low in fats and carbohydrates, and which have moderate amounts of proteins. Unfortunately, the '949 Patent fails to disclose a means for reducing carbohydrate intake from snack foods. U.S. Patent Application 2003/0108654 A1 discloses a dry mix and process for using said mix to make a low carbohydrate potato product. Dry mixes are not usually considered “ready to eat” foods, as water must first be added and the resulting dough composition mixed and cooked prior to consumption. In addition, the application indicates that the product made from the dry mix are not shelf stable unless dried. If the products are dried, though, they may not be ready to eat. Thus, the invention disclosed in the '654 application fails to provide a convenient, ready to eat, shelf-stable, and low carbohydrate snack food. Hence, there is a need for a low carbohydrate snack food.

Many convenient, shelf-stable, ready to eat snack foods are high in carbohydrates. This reality makes it difficult for consumers to maintain a low carbohydrate diet. In addition, many consumers have become accustomed to supplementing their meals with convenient snack foods, adding more difficulty to maintaining a low carbohydrate diet. Although the '772 Patent, discussed above, indicates that the starting raw materials can be based primarily on ingredients including soy isolate and soy concentrates, it is very difficult to substitute these high protein ingredients for the corn meal because of the natural tendency for the extruded high protein product to develop off flavors and a chalky texture because of the high temperature, high pressure, and high specific mechanical energy (“SME”) operating parameters typically encountered in conventional direct expanded extrusion processes. An imparted SME of between about 100 to about 210 watt-hours per kilogram of extrudate is considered a high SME. Thus, the use of a soy protein as a bulking agent in puffed snack products has not been commercially successful because the expansion and structural/textural characteristics of the expanded soy collets does not occur in the same manner as starch-based collets. Starch provides the molecular matrix required to hold the foamy structure of a puffed snack food. Starch is typically in the form of starch-rich and thereby carbohydrate-rich corn meal. Unfortunately, large quantities of carbohydrate rich cornmeal is undesirable in low carbohydrate foods. Hence, there is a need in the art for a process for manufacturing a reduced or low carbohydrate puffed snack product with taste and texture characteristics similar to conventionally produced puffed snack products.

One prior art attempt to solve this problem is disclosed in U.S. Patent Application No. 2003/0064145 A1, entitled “Puffed Protein Based Snack Food.” The '145 patent application discloses a low-density snack food comprising a solids matrix of protein, an optional carbohydrate filler, and a fat content not to exceed 30%. The taste and texture characteristics of this product, however, fails to mimic the taste and texture characteristics of a conventionally produced puffed snack product. For example, there is no discussion in the disclosure how the off flavors known to inherently develop in extruded high protein compounds, were avoided. In addition, there is no discussion about the inclusion of corn meal. Consequently, there is a need in the art for a process for manufacturing reduced carbohydrate puffed snack product with taste and texture characteristics similar to conventionally produced puffed snack products.

Another prior art solution for a low carbohydrate snack food is disclosed in U.S. Pat. Nos. 6,291,009 and 6,479,089 which disclose a soy based dough and products made from the dough. However, these patents are clearly directed toward a sheeted dough. These patents fail to disclose a way to avoid off flavors that develop because of high temperature, high pressure, and high SME operating parameters typically encountered in conventional extrusion processes.

Consequently, there is a need in the art for a process for manufacturing reduced carbohydrate puffed snack product with taste and texture characteristics similar to conventionally produced puffed snack products. The low carbohydrate snack food should emulate the organoleptical properties, including taste and texture, of a conventionally produced puffed snack product. The snack food should be shelf stable and ready to eat.

### SUMMARY OF THE INVENTION

The proposed invention provides a low carbohydrate puffed snack food and method for making. In one embodiment, the invention uses a combination of soy proteins, namely soy concentrate and soy isolate, combined with a ground corn raw ingredient. The dry mix of ingredients is optionally hydrated with water. The ingredients are extruded through an exit die at specific operating conditions to form a puffed snack. The puffed snack can be dried and oil and/or seasoning can be added.

Hence, this invention produces a low carbohydrate puffed snack food and method for making whereby a low carbohydrate snack is made that mimics the taste, and texture characteristics of conventionally produced, high carbohydrate puffed snack products. In addition, the low carbohydrate snack food is shelf stable and ready to eat. The above as well as additional features and advantages of the present invention will become apparent in the following written description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a side view of the apparatus used for making the puffed snack product of the present invention.

FIG. 2a is an enlarged top plan view of the die assembly mounted on the end of a twin screw extruder.

FIG. 2b is an end view of the orifice plate that comprises part of the die assembly shown in FIG. 2a.

FIG. 3a is a perspective view of a collet made from one embodiment of the present invention.

FIG. 3b is a perspective view of a collet made from an alternative embodiment of the present invention.

### DETAILED DESCRIPTION

The low carbohydrate direct expanded snack product of the present invention is prepared from ingredients comprising soy isolate, soy concentrate, and a ground corn raw material such as corn meal. The soy protein isolate, soy protein concentrate, and corn meal are ingredients well known in the art. Corn meal typically comprises about 9% protein, 8% fiber, and 80% net carbohydrate. As used herein, net carbohydrates is synonymous with carbohydrate and is defined as a digestible carbohydrate. Dietary fiber is not a digestible carbohydrate. As used herein, dietary fiber and fiber are used interchangeably and include both soluble and insoluble fiber. Unless indicated otherwise, all percentages discussed herein are by weight.

A ground corn product, such as degermed yellow corn meal, available from Bungee Milling, of Danville, Ill. can be used. As used herein, a ground corn product is defined as a wet or dry substantially ground corn kernel product and includes, but is not limited to, corn masa, corn meal, corn flour, corn starch, and mixtures thereof.

Soy protein concentrate and soy protein isolate are prepared by removing most of the water soluble, non-protein (e.g. carbohydrate) constituents from dehulled and defatted soybeans. Soy protein isolate, for example, typically comprises 90% protein, and has negligible dietary fiber and carbohydrates. A soy protein isolate, such as ProFam 880, available from ADM, of Decatur, Ill. can be used. As used herein, soy protein isolate is defined as a protein mixture derived from a soybean having at least 90% wet basis by weight protein. Soy protein concentrate typically comprises 70% protein, 20% fiber, and has negligible carbohydrates. A soy protein concentrate, such as Arcon F, available from ADM, of Decatur, Ill. can be used. As used herein, soy protein concentrate is defined as a protein mixture derived from a soybean having between about 65% to about 90% wet basis by weight protein.

In one embodiment of the invention, the soy isolate to soy concentrate is in a ratio of about 3.50:1 to 2.50:1. This ratio tends to optimize expansion characteristics of the puff extrudate from the extruder, as well as flavor and color characteristics. As more soy concentrate is added relative to soy isolate, the color becomes more brown and a bitter off-flavor becomes more apparent.

Soy flour is typically made by grinding and screening soybean flakes either before or after removal of soybean oil. Soy flour typically comprises 50% protein, 20% fiber, and 10% carbohydrates. As used herein, soy flour is defined as a ground soy derived from a soybean having less than about 65% wet basis by weight protein. It is preferable that soy protein isolate and soy protein concentrate be used rather than soy flour because of the higher protein contents in the soy isolate and soy concentrate. Use of soy flours also contributes to more apparent off-flavors. However, off-flavors can be masked with the addition of heat stable flavors added to the ingredients or topicals such as seasoning slurries added to the extruded product. Thus, in one embodiment of the invention, a de-fatted or full-fat soy flour can be used. Although soy-based proteins are disclosed in some embodiments of this invention, other protein sources can be used, either in lieu of, or in combination with the soy-based proteins including, but not limited to, dairy-based proteins, wheat-based proteins, rice-based proteins and egg-based proteins. Moreover, other legume-based protein sources other than soy can be used including, but not limited to, beans, lentils and peas. Soy-based proteins are currently most advantageous because of cost and functionality considerations.

Fiber, including, but not limited to, oat fiber, bamboo fiber, potato fiber, corn bran, rice bran, and wheat bran can be used to reduce the amount of net carbohydrates in the resultant food product and can thus be added as ingredients without increasing carbohydrate content (as defined above in this application) of the food product.

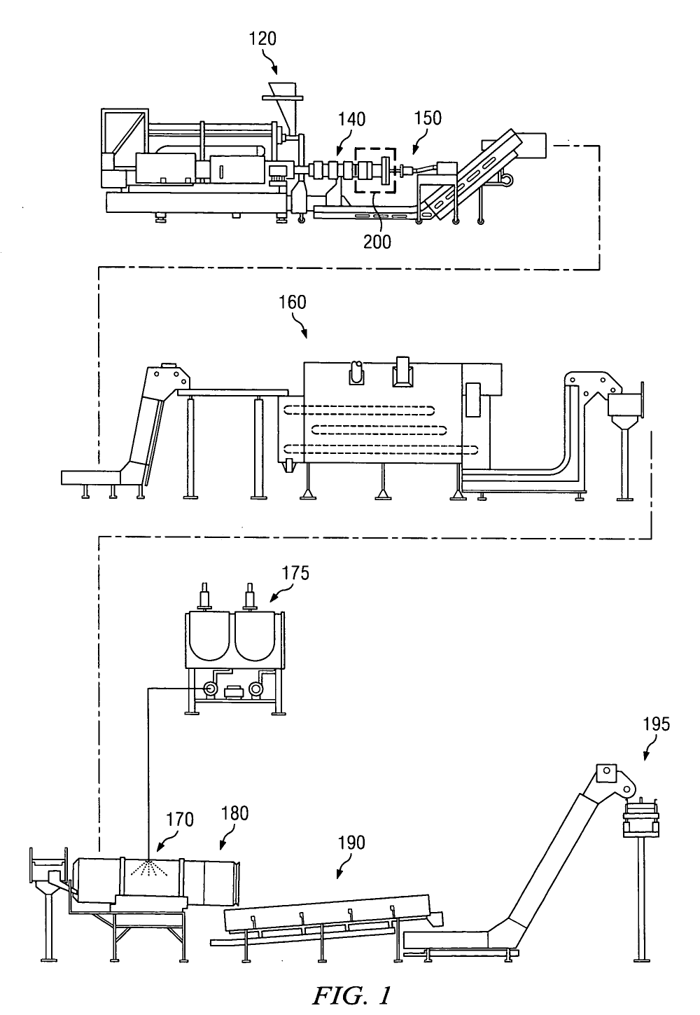

FIG. 1 is a side view of the apparatus used for making the puffed snack product of the present invention. In one embodiment, ingredients comprising about 25 percent to about 40 percent ground corn product, about 30 percent to about 60 percent soy isolate, and about 10 percent to about 20 percent soy concentrate are mixed to form a dry ingredient mixture and conveyed into a hopper 120. The ingredients can be pre-mixed or added separately to and mixed inside the twin screw extruder 140. In one embodiment, a single screw extruder is used.

The ingredients can be hydrated prior to entry into the extruder 140 or while inside a twin screw extruder 140. In one embodiment, the extruder 140 is operated at a screw speed of about 100 to about 475 revolutions per minute (RPM) until a total moisture content of between about 15% to about 30% is achieved. A BC-45 twin screw extruder, available from Clextral Inc, of Tampa, Fla. can be used. Lower moisture contents tend to cause higher extrudate temperature, and can result in subsequent undesirable flavor.

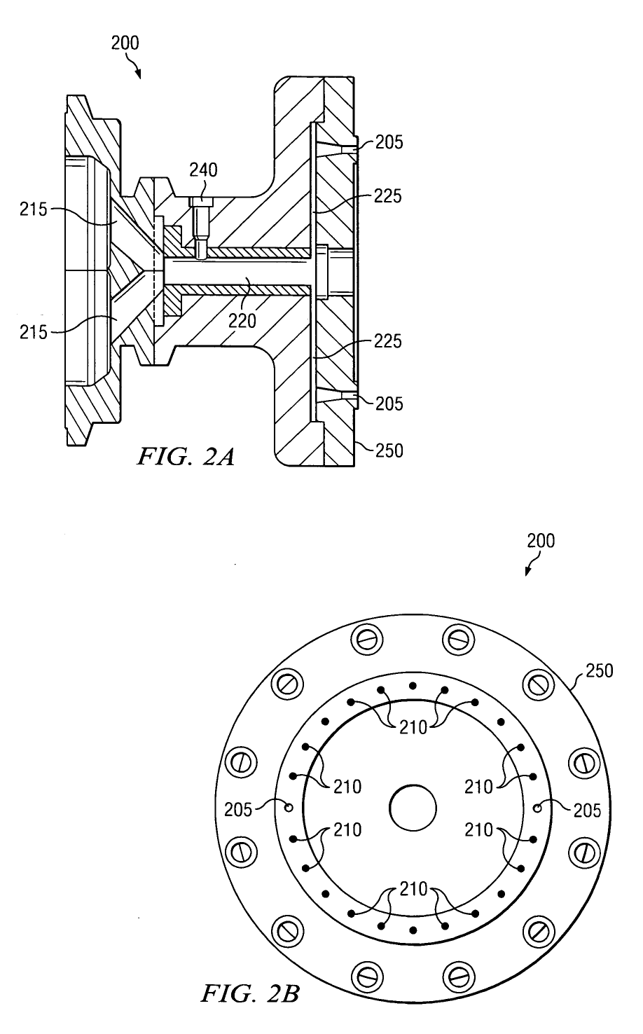

FIG. 2a is an enlarged top plan view of one example of a die assembly mounted on the end of a twin screw extruder. FIG. 2b is an end view of the orifice plate 250 that comprises part of the die assembly shown in FIG. 2a. The orifice plate 250 can comprise any desired combination of open orifices 205 and closed orifices 210 as desired. Referring to FIG. 2a and FIG. 2b, as the ingredients approach the die exit 205, a viscous melt is made as the ingredients are heated to a die temperature of between about 350° F. to about 425° F., or more preferably between about 370° F. and about 390° F. and is forced from the extruder screws through converging channels 215 through the central feed channel 220 and radial channel 225 toward the die exit 205 at a die pressure between about 500 and about 2000 pounds per square inch (psi), or more preferably between about 600 and about 1400 psi. As used herein, die pressure is the pressure of the viscous melt after the extruder screws prior to reaching atmospheric pressure conditions and can be measured in the central feed channel 220 by instrumentation placed into a thermowell 240. As used herein, die temperature is the temperature of the raw materials just after the extruder screws and can also be measured in the central feed channel 220.

The raw materials then exit through an orifice 205 in an orifice plate 250 to atmospheric pressure and ambient temperature. Upon exit from the orifice 205, the extrudate expands, flashes vapor, cools, and very quickly goes from a flowable plastic melt stage to a relatively rigid, glassy structure typical of a puffed snack. In one embodiment, the extruder imparts a specific mechanical energy of between about 100 to about 210 watt-hours per kilogram of extrudate to the ingredients. This specific temperature and pressure range provides a highly desirable, finished characteristic to the puffed snack product. Surprisingly, the above formulation can be used in a high SME extruder and not present the undesirable off-flavors typically encountered in extruded soy-based products. Further, these formula ranges have been determined to maximize the volumetric expansion index at the set operating conditions while keeping texture, color, and flavor acceptable.

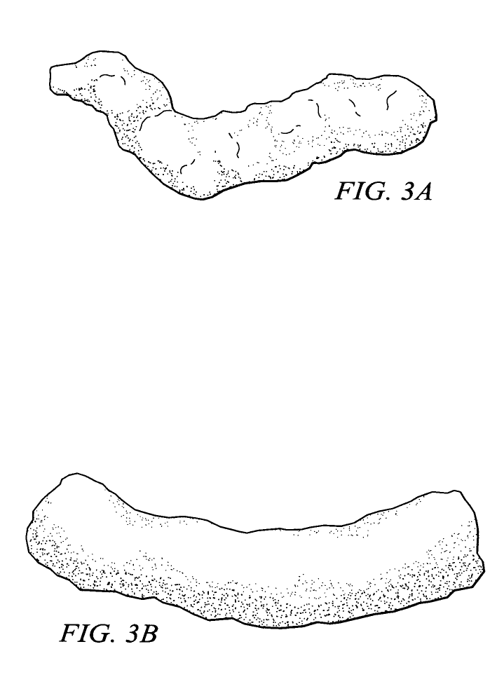

Another unexpected surprising discovery pertains to the flow rate through each orifice 205. FIG. 3a is a perspective view of a low carbohydrate collet 310 made from one embodiment of the present invention. As disclosed in U.S. Pat. No. 6,607,772, assigned to the same assignee as the present invention, the flow rate through each prior art die can be 80 pounds per hour. Such a flow rate through an orifice having a diameter of about 3 millimeters to about 4 millimeters with the ingredients of the present invention can result in the low carbohydrate collet 310 depicted in FIG. 3a. As illustrated, the collet 310 has a rough, non-uniform surface appearance. The collet 310 tightly arcs in varying directions. Expansion of the collet 310 appears non-uniform.

FIG. 3b is a perspective view of a low carbohydrate collet 320 made from an alternative embodiment of the present invention. As illustrated, the collet 320 has a smoother, more uniform surface appearance. The collet 320 gently arcs in a substantially single direction. It was unexpectedly discovered that the product depicted in FIG. 3b can be made by increasing the flow rate through each open orifice 205, as shown in FIG. 2b, above 100 pounds per hour, more preferably between about 150 pounds per hour and about 250 pounds per hour. In one embodiment, the flow rate through each orifice is between about 250 pounds per hour and about 300 pounds per hour. Although the above flow rates are based upon a substantially circular orifice having a diameter of about 3 millimeters to about 4 millimeters, one skilled in the art will appreciate that different orifice sizes will require different flow rates to achieve the same results. This invention should be construed to include the flux that results from the specified range of flow rates through the cross-sectional area of the specified orifice size range. Prior to this discovery, the low carbohydrate collets were produced by extruding less than about 50 pounds per hour through each orifice to minimize the natural tendency for the extruded high protein product to develop toasted off flavors and a chalky texture because of the high temperature, high pressure, and high SME operating conditions.

This discovery is counterintuitive because experts in the field teach that proteins are very shear sensitive and caution must be exercised with the shear force imparted upon proteins. Here the shear at these orifice flow rates is extremely high, perhaps an order of magnitude higher than product extruded at rates through each orifice between 25 pounds per hour and 40 pounds per hour.

Without being limited to theory, it is believed that high shear forces resulting from extruding through an orifice at such a high rate affects the behavior of the extrudate. This high velocity, high rate of flow results in a shear rate that is higher at the die assembly 200 as shown in FIG. 1 than the prior art process. Thus, more of the SME work and/or the pressure drop imparted to the extrudate within the die assembly 200/extruder 140 assembly is imparted at the die assembly 200 as depicted in FIG. 2a. The high pressure drop across the die assembly 200 causes expansion of the protein/starch extrudate. The extrudate solidifies very quickly upon exit from the die assembly 200 so the expanded matrix or collet 320, as depicted in FIG. 3b, substantially retains the cylindrical shape that was formed in the in the orifice. Further, it is believed that because of high extrudate velocity, the protein fibers do not have the requisite residence time required in the die assembly to react or exhibit elastic behavior by shrinking upon expansion.

Referring back to FIG. 1, immediately upon exiting the die assembly 200, the extrudate can be cut by circular cutting apparatus 150 into reasonable sized pieces. The moisture content of the puffed snack is about 4% to about 12%, which can be too high to maintain desirable texture crispness. The puffed snack, in one embodiment, can be routed along conveyors and can be dehydrated to a moisture content of between about 0.8% to about 2.0% or more preferably between about 0.8% to about 1.2% by weight of the product. The puffed snack can be dehydrated, for example, in a three pass dryer 160 at a temperature between about 250° F. to about 325° F. for about 5 to 12 minutes. Higher temperatures should be avoided to prevent undesirable off-flavors. In an alternative embodiment, the puffed snack, upon exiting the extruder die can be air dried or fried, and then seasoned as required. In another embodiment, the puffed snack, upon exiting the extruder die can be sent directly to a seasoning slurry prior to being deydrated to a moisture content of between 0.8 to about 1.2% by weight of the product.

A prior art seasoning slurry 170 comprises about 1 part by weight water, about 1 part by weight powder or finely granulated flour, and about 4 parts by weight oil. (See U.S. Pat. No. 4,985,262). The seasoning slurry 170 can impart flavors including, but not limited to cheese, ranch, and barbeque. In addition, the seasoning slurry 170 can comprise nutrients including, but not limited to, vitamins and minerals. The seasoning slurry 170 is typically pumped from supply tanks 175 and added while the puffed snack is being tumbled, for example, in a rotating seasoning drum 180 of the type typically used to commercially apply seasoning to snacks. Like prior art puffed snacks, some embodiments of the present invention produce a non-seasoned puffed snack having a density between about 0.02 to about 0.10 grams per cubic centimeter. As used herein, density is defined as the density of the collet after drying to a moisture content of 1.2% by weight.

The puffed snack of the present invention comprises numerous air pockets or void spaces interspersed within the puffed snack or collet giving the puffed snack a high porosity. As the puffed snack cools after exiting the drier 160, the air within these pockets cools, forming a vacuum effect inward from the outside of the collet. Thus, when the puffed snack is sent through a seasoning slurry 170 shortly upon exit from the drier 160, the slurry is pulled by this vacuum effect into the porous areas of the collet.

In some embodiments of the present invention, perhaps as a result of the ingredient formulation and/or process conditions, a denser puffed snack is produced. For example, the puffed snack of the present invention comprises a density that, in one embodiment, can reach 0.20 grams per cubic centimeter after the puffed snack has been seasoned. Hence, the collet in some embodiments of the present invention is less porous, resulting a reduced vacuum effect to pull in seasoning slurry and less void space for seasoning to be deposited. Further, absorption of the seasoning slurry is further reduced because of a skin layer that forms as a result of the extrusion process. Therefore, in one embodiment, the present invention uses an oil to fine powder ratio of between about 0.8 to about 2.0 parts of oil for every 1 part of fine powder to ensure a higher concentration of seasoning is applied to the puffed snack. The seasoned puffed snack can be cooled on conveyors 190 as it is routed to be packaged 195.

In one embodiment, the fat content, following seasoning of the puffed snack is between about 30% to about 40%. In one embodiment, the puffed snack comprises between about 12% and about 18% of seasoning by dry weight of the product.

Hence, this invention produces a low carbohydrate direct expanded snack and method for making whereby a low carbohydrate puffed snack food is made that mimics the taste, and texture characteristics of conventionally produced, high carbohydrate puffed snack products. Further, there is minimal off-flavor that is typically present in high protein extruded food products. In addition, the low carbohydrate snack food is shelf stable and ready to eat.

While this invention has been particularly shown and described with reference to a preferred embodiment, it will be understood by those skilled in the art that various changes in form and detail may be made therein without departing from the spirit and scope of the invention.

What is claimed is:

1. A method for making a low carbohydrate puffed snack comprising:
a) introducing into an extruder ingredients comprising:
about 25 percent to about 40 percent ground corn product;
about 30 percent to about 60 percent soy isolate;
about 10 percent to about 20 percent soy concentrate;
b) extruding said ingredients through said extruder having an exit die to form a puffed snack wherein said extruder further comprises;
a die pressure between about 600 to about 1400 pounds per square inch; and
a die temperature between about 350° F. to about 425° F.

2. The method of claim 1, further comprising the step of:
c) dehydrating said puffed snack to a moisture content of between about 0.8 percent and about 1.2 percent by weight.

3. The method of claim 1, further comprising the step of:
d) seasoning said puffed snack.

4. The method of claim 1, wherein said ingredients at step a) are mixed in said extruder.

5. The method of claim 1, wherein said ingredients at step a) are pre-mixed prior to entry into said extruder.

6. The method of claim 1, wherein said ground corn product at step a) is selected from the group consisting of corn masa, corn meal, corn flour, corn starch, and mixtures thereof.

7. The method of claim 1, wherein a ratio of soy isolate to soy concentrate is between about 3.50:1 to 2.50:1 by weight.

8. The method of claim 1, wherein said ingredients at step b) comprises a moisture content between about 20 percent to about 29 percent.

9. The method of claim 1, wherein said extruder operates at least one screw at about 100 to about 475 revolutions per minute.

10. The method of claim 1, wherein said extruder imparts a specific mechanical energy of between about 100 to about 210 watt-hours per kilogram of extrudate.

11. The method of claim 2, wherein said dehydrating at step c) occurs at less than about 325° F.

12. The method of claim 2, wherein said dehydrating at step c) occurs by frying said puffed snack.

13. The method of claim 3, wherein said seasoning at step d) comprises an oil to fine powder ratio of between about 0.8 to about 2.0 parts of oil for each part of fine powder.

14. The method of claim 3, wherein said puffed snack comprises a density between about 0.02 and about 0.20 g/cc.

15. The method of claim 3, wherein said puffed snack comprises between about 12% and about 18% seasoning by dry weight of product.

16. The method of claim 1, wherein said puffed snack comprises a density between about 0.02 and about 0.10 g/cc.

17. The method of claim 1, wherein said puffed snack comprises:
about 25% to about 40% carbohydrates;
about 30% to about 40% protein; and
about 30% to 40% fat.

18. The method of claim 1, wherein said ingredients have a flow through said exit die having an orifice substantially between about 3 millimeters and about 4 millimeters wherein said flow is between about 100 pounds per hour to about 300 pounds per hour through said orifice.

19. A puffed snack made by the method of claim 1.

20. A reduced carbohydrate dry mix comprising dry ingredients, wherein said dry ingredients further comprise:
about 25 percent to about 40 percent ground corn product;
about 30 percent to about 60 percent soy isolate; and
about 10 percent to about 20 percent soy concentrate.

21. The reduced carbohydrate dry mix of claim 20 wherein said ground corn product is selected from the group consisting of corn masa, corn meal, corn flour, corn starch and mixtures thereof.

22. The reduced carbohydrate dry mix of claim 20 wherein said soy concentrate comprises between about 65% to about 80% wet basis by weight protein.

23. The reduced carbohydrate dry mix of claim 20 wherein said soy isolate comprises at least 90% wet basis by weight protein.

24. The reduced carbohydrate dry mix of claim 20 wherein a soy isolate to soy concentrate ratio comprises about 3.50:1 to 2.50:1.

25. The reduced carbohydrate dry mix of claim 20, wherein said dry mix is hydrated and comprises wet ingredients including water from about 15% to about 30% by weight of said wet and said dry ingredients.

26. A puffed snack made from the reduced carbohydrate dry mix of claim 20.

27. A low carbohydrate extruded snack food wherein said low carbohydrate snack food comprises:
about 15% to about 30% carbohydrates, wherein at least 50% of said carbohydrates are derived from a ground corn product;
about 30% to about 40% protein; and
about 0% to about 5% fiber;
about 30% to 40% fat; and
about 0.5% to about 2% moisture.

28. The low carbohydrate snack food of claim 27 wherein said ground corn product is selected from the group consisting of corn masa, corn meal, corn flour, corn starch and mixtures thereof.

29. The low carbohydrate snack food of claim 27 wherein said snack food is extruded at a die pressure between about 800 to about 1400 pounds per square inch; and a die temperature between about 350° F. to about 425° F.

30. The low carbohydrate snack food of claim 27 wherein said snack food is processed in an extruder that operates at least one screw at about 100 to about 475 revolutions per minute.

31. The low carbohydrate snack food of claim 27 wherein said snack food is processed in an extruder that imparts a specific mechanical energy of between about 100 to about 210 watt-hours per kilogram of extrudate.

32. The low carbohydrate snack food of claim 27 that further comprises between about 12% and about 18% seasoning by dry weight of product.

33. The low carbohydrate snack food of claim 27 wherein said snack food comprises a density between about 0.02 and about 0.20 grams per cubic centimeter.

34. The low carbohydrate snack food of claim 27 wherein said snack food is extruded at a flow rate through an exit die having an orifice substantially between about 3 millimeters and about 4 millimeters wherein said flow rate is between about 100 pounds per hour to about 300 pounds per hour through said orifice.
